(19) United States
(12) Patent Application Publication
(10) Pub. No.: US 2026/0318143 A1
(43) Pub. Date: Oct. 15, 2026

(54) APPARATUS, METHOD AND SYSTEM FOR BUILDINGS WITH ELECTRICAL GATE SYSTEMS FOR REMOTE DIAGNOSIS AND REMOTE MAINTENANCE OF AN ELECTRICAL GATE SYSTEM

(71) Applicant: BOTEVO Building Solutions GmbH, Sinn (DE)

(72) Inventors: Mathias HILD, Sinn (DE); Marlon REIMANN, Greven (DE); Marius OSKAMP, Greven (DE); Michael PELSTER, Altenberge (DE)

(21) Appl. No.: 19/166,284

(22) PCT Filed: Mar. 15, 2024
(86) PCT No.: PCT/EP2024/057060

§ 371 Date: Sep. 17, 2025

(30) Foreign Application Priority Data
Mar. 17, 2023 (EP) 23162683.9
Mar. 31, 2023 (EP) 23166133.1

(51) Int. Cl. E05F 15/70; E05F 15/603

(52) U.S. Cl. CPC E05F 15/70; E05F 15/603; E05Y 2400/40; E05Y 2400/458; E05Y 2400/502; E05Y 2400/818

(57) ABSTRACT

The present invention relates to electrical gate systems and in particular to a method and a system for remote diagnosis and remote maintenance of an electrical gate system. The present invention further relates to a detection unit for electrical gate systems, a corresponding electrical gate system with such a detection unit, a system for buildings comprising such a detection unit, a corresponding method and a corresponding computer-readable storage medium.

### BACKGROUND OF THE INVENTION

### Field of the Invention

The present invention relates to electrical gate systems and in particular to a method and a system for remote diagnosis and remote maintenance of an electrical gate system. The present invention further relates to a detection unit for electrical gate systems, a corresponding electrical gate system with such a detection unit, a system for buildings comprising such a detection unit, a corresponding method and a corresponding computer-readable storage medium.

### Description of the Prior Art

A large number of electrical gate systems are known, for example garage gates, industrial gates, special gates, sectional gates, folding gates, hangar gates, rolling gates, lifting gates, sliding gates, high-speed gates or rolling-grid gates. Such electrical gate systems are used, for example, in critical infrastructure (fire department, rescue workers, police), in producing companies (intralogistics and production, logistics centers, car parks, underground garages) and in traffic infrastructure (depots, road and motorway masters, airports).

Factors such as unnecessarily long open service lives and uncoordinated opening and closing processes, in particular for buildings with a large number of electrical gate systems, can bring about considerable energy losses and thus make energy- and CO₂—efficient operation more difficult. In addition, the determination and adaptation of a room climate to a desired room climate in corresponding buildings is made more difficult by these and other factors, for example in industrial halls with a plurality of electrical gate systems.

Owing to further factors such as, for example, heavy use, weather effects and relatively long-term wear, electrical gate systems can have a high susceptibility to faults. Correspondingly high failure risks can result therefrom, which in turn can lead to high maintenance costs, for example owing to a high personnel requirement for maintenance and troubleshooting on site. In addition, considerable energy losses can arise owing to unnecessarily long open service lives and safety risks owing to unclosed gate systems. At the same time, virtually all electrical gate systems which are in operation today are of analogous design and have to be serviced on site in a complex manner.

There is therefore a need to develop solutions for buildings with electrical gate systems and solutions for the remote diagnosis and remote maintenance of electrical gate systems which avoid the disadvantages listed.

### SUMMARY OF THE INVENTION

The invention is defined in the independent claims. Advantageous embodiments are defined in the dependent claims.

Proceeding from the problems presented above, the present invention is intended to provide a method for remote diagnosis and remote maintenance of an electrical gate system. The method comprises providing, by a gate controller of an electrical gate system, status information regarding a status of the electrical gate system via an interface to which a local device can be connected by means of which a local user can be informed about the status. The method further comprises automatically accessing, by a control module coupled to the gate controller, the status information and providing the status information to processing means. The method further comprises processing, by the processing means, the status information and providing the processed status information to a communication module coupled to the control module. The method further comprises communicating, by the communication module, the processed status information to a remote maintenance unit.

The provided method makes it possible to establish a remote diagnosis for an electrical gate system and to maintain the electrical gate system remotely. According to the invention, different status information which is provided by the gate controller merely for informing a user on site can be used by the automatic access for remote diagnosis and remote maintenance and correspondingly communicated to a remote maintenance unit. By automatically accessing status information which hitherto serves merely for informing a local user, the provided method can be applied to existing gate controllers of different manufacturers. In particular, the provided method makes it possible to provide comprehensive status information about the state of the electrical gate system for the remote maintenance unit without maintenance personnel having to be active on site. The provided method can be used both for new systems and for existing systems, for example as a retrofit solution.

In an advantageous embodiment, providing the status information for informing a local user comprises providing, via a display interface, the status information to a local display.

A user or maintenance personnel can detect the status information on site via the local display. Providing the status information via a display interface makes it possible according to the invention to automatically access the status information and thus provide the status information for further processing and communicating to the remote maintenance unit.

In a further advantageous embodiment, automatically accessing the status information comprises tapping, by signal tapping means, a signal transmitted via the display interface. The signal comprises the status information.

Using suitable signal tapping means makes it possible to automatically access the signal transmitted via the display interface comprising the status information. Tapping takes place automatically, that is to say in particular without maintenance personnel having to be on site.

In a further advantageous embodiment, processing the status information comprises decoding, by the processing means, the tapped signal comprising the status information.

By decoding the tapped signal, the status information can be taken from the tapped signal and made usable for the remote maintenance unit.

In a further advantageous embodiment, tapping comprises obtaining, by an optical coupler, the signal transmitted via the display interface.

The use of an optical coupler for tapping the signal comprising status information from the display interface makes it possible to access the status information independently of the fact that the status information was originally intended merely for informing a local user, and independently of the manufacturer.

In a further advantageous embodiment, the status information comprises one or more information, such as, for example, motor status information relating to a status of a motor of the electric gate system, including torque, current or shaft position. The status information can further comprise gate control status information relating to a status of the industrial control, in particular a fault status.

The different status information allows precise diagnosis of the gate state and correspondingly effective and efficient remote diagnosis and corresponding remote maintenance.

In order to achieve the abovementioned object, the present invention also provides a system for remote diagnosis and remote maintenance of an electrical gate system. The device comprises a control module configured to be coupled to a gate controller of the electrical gate system, wherein the gate controller is configured to provide status information regarding a status of the electrical gate system via an interface to which a local device can be connected by means of which a local user can be informed about the status. The control module is configured to automatically access the status information and provide the status information to processing means, wherein the processing means is configured to process the status information and provide the processed status information to a communication module coupled to the control module. The communication module is configured to communicate the processed status information to a remote maintenance unit.

In an advantageous embodiment, providing the status information for informing a local user comprises providing, via a display interface, the status information to a local display.

In a further advantageous embodiment, the control module for automatically accessing the status information comprises signal tapping means configured to tap a signal transmitted via the display interface, the signal comprising the status information.

In a further advantageous embodiment, the processing means for processing the status information is configured to decode the tapped signal comprising the status information.

In a further advantageous embodiment, the signal tapping means comprises an optical coupler configured to obtain the signal transmitted via the display interface.

In a further advantageous embodiment, the status information comprises one or more information, such as, for example, motor status information relating to a status of a motor of the electric gate system, including torque, current or shaft position. The status information can further comprise gate control status information relating to a status of the control of the electric gate system, in particular a fault status.

In order to solve the problems presented above, the invention also provides a detection unit for an electrical gate system. The detection unit comprises coupling means for coupling the detection unit to a gate controller of the electrical gate system. The detection unit further comprises environmental data detection means configured to detect environmental data, and status detection means configured to detect a status of the electrical gate system, wherein the status is queried by the gate controller and thus detected. In addition, the detection unit comprises action requirement detection means configured to determine an action requirement based on the detected environmental data and the detected status, and reporting means configured to report the determined action requirement.

The provided detection unit makes it possible to detect the status of an electrical gate system and to determine an action requirement, for example for an industrial hall in which the electrical gate system is installed. The thus determined action requirement can then be reported, for example to a user on site or to a remote maintenance unit, which can take measures depending on the determined action requirement, for example opening or closing the electrical gate system. The provided detection unit can be used both for new systems and for existing electrical gate systems, for example as a retrofit solution.

In an advantageous embodiment, the reporting means comprises signaling means configured to provide a visual and/or acoustic output, and transmission means configured to transmit to a remote receiver.

The reporting means make it possible, for example, to alert a user on site to a certain situation and to prompt action, for example to open or close the electrical gate system. The reporting means also make it possible to inform a remote receiver about the action requirement, so that they can initiate corresponding measures. The visual and/or acoustic signaling is an efficient measure to alert a user on site to a certain state and to prompt him to take suitable measures. If the user is not on site, a corresponding, for example visual or acoustic, notification can alternatively or additionally be used on a mobile terminal associated with him to inform him of the situation on site and thus possibly prompt him to take action.

In a further advantageous embodiment, the action requirement detection means is further configured to determine an action recommendation based on the determined action requirement. Accordingly, the reporting means is further configured to report the determined action recommendation.

In this way, a (local or remote) user or a remote maintenance unit can not only be alerted to the determined action requirement, but a specific recommendation can also be made as to how the situation that led to the determination of the action requirement can be changed and in particular improved.

In a further advantageous embodiment, the acquired environmental data comprise interior environmental data and exterior environmental data. The interior environmental data can in this case comprise, for example, an interior temperature, an interior air pressure and an interior humidity, which determine the room climate, for example in an industrial hall. The exterior environmental data can comprise, for example, an exterior temperature, an exterior air pressure and an exterior humidity, which determine the climate in the exterior region of an industrial hall. The interior environmental data can also comprise a carbon dioxide content of the interior air, a carbon monoxide content of the interior air, a degree of turbulence of the interior air, a hazardous material load of the interior air and a noise level.

The acquisition of a multiplicity of interior and exterior environmental data allows a precise determination of the room climate in a hall and therefore facilitates a determination of an action requirement and, if appropriate, a determination of an action recommendation, in order thus, for example, to avoid energy losses or to reduce an existing pollutant load or an excessively high noise level (for example owing to strong noise emissions from outside an industrial hall or for minimizing the noise emission prevailing in the hall).

In a further advantageous embodiment, the status information acquisition means are configured to acquire gate position information relating to a position of the electric gate system, comprising an open position and a closed position, and to acquire time information relating to a duration of a current status of the electric gate system and gate control status information relating to a status of the gate control, including a fault status. The gate position information relating to a position of the electric gate system can in this case be based in particular on a drive state of a drive of the electric gate system, wherein the drive state defines an opening area of the electric gate system.

In this way, the state of an electric gate system can be acquired in a very detailed manner. Since not only the states open or closed are detected, but the gate open state can be determined based on the drive state of the drive of the electric gate system, it is possible to determine the action requirement exactly and to suitably determine possible action recommendations.

In a further advantageous embodiment, reporting the determined action requirement comprises reporting the determined action requirement to a remote maintenance unit using the transmission means.

The remote maintenance unit can then initiate suitable measures based on the determined action requirement and optionally based on the determined action recommendation, in order to change and in particular improve the situation on site that led to the determination of the action requirement. In this way, in addition or as an alternative to notifying a user on site, remote intervention is made possible, so that a complex use of personnel on site can be partially or completely avoided.

In a further advantageous embodiment, determining the action requirement comprises calculating an energy loss. Calculating the energy loss is based at least on a comparison of the interior environmental data and the exterior environmental data. Further, calculating the energy loss is based on the status of the electric gate system, the opening area of the electric gate system, a spatial position of the electric gate system and/or an area of a room in which the electric gate system is installed.

Taking account of the said factors makes it possible to calculate the energy loss exactly, which is caused, for example, by an unnecessary gate open state. This energy loss can be reported directly to a user on site or to a remote user or also to a remote maintenance unit. In this way, it is possible to react quickly and efficiently in order to take corresponding measures to avoid or eliminate the energy loss.

In a further advantageous embodiment, determining the action requirement further comprises determining a current room climate based on the status of the electric gate system and the environmental data, and comparing the current room climate and a predetermined room climate. In this case, the action recommendation is further based on a result of comparing the current room climate and the predetermined room climate and is suitable for adapting the current room climate to the predetermined room climate.

The detection unit according to the invention makes it possible to detect deviations from a desired room climate, for example with regard to a temperature, a carbon dioxide or carbon monoxide content, a degree of turbulence, another hazardous material load or also a noise level. Based thereon, the detection unit can give corresponding action recommendation in order to adapt and in particular optimize the current room climate.

In order to solve the problems presented above, the invention also provides an electrical gate system which comprises the detection unit explained above.

In a further embodiment, the detection unit is installed in the immediate vicinity of the electric gate system, in particular at a distance of at most 5 m from the electric gate system, measured from a gate frame of the electric gate system.

The installation of the detection unit in the immediate vicinity of the electric gate system makes it possible to determine the environmental data exactly.

In order to solve the problems presented above, the invention also provides a system for a building. The system comprises the detection unit explained above.

In order to solve the problems presented above, the invention also provides a corresponding method for the detection unit explained above. The method comprises detecting environmental data, detecting a status of the electric gate system, determining an action requirement based on the detected environmental data and the detected status, and reporting the determined action requirement.

In order to solve the problems presented above, the invention also provides a computer-readable storage medium which comprises instructions which, when executed by a computer, cause the latter to carry out the method explained above.

Both the above general description and the detailed description are to be understood as examples and are intended to serve to explain the claimed invention. Further advantages and features of the invention will become apparent from the following description, the drawings and the claims.

### BRIEF DESCRIPTION OF THE DRAWINGS

The features of the invention are explained in more detail in the appended claims.

However, the invention itself can best be understood on the basis of the following detailed description, which describes an exemplary embodiment of the invention with reference to the drawings:

FIG. 1 is a schematic illustration of a system according to the present invention.

FIG. 2 is a flowchart relating to the operation of the method according to the present invention.

FIG. 3 is a schematic illustration of a detection unit according to an embodiment of the present invention.

FIG. 4 is a flowchart relating to the operation of the method according to an embodiment of the present invention.

### DETAILED DESCRIPTION OF THE INVENTION

The accompanying drawings, the technical content and the detailed description relate to a preferred embodiment of the invention, but this is not to be understood as a limitation of the subject matter of the invention. All equivalent variations and changes which are made in accordance with the appended claims of the present invention are covered by these claims.

In the following, the invention will be described in detail with reference to the drawings.

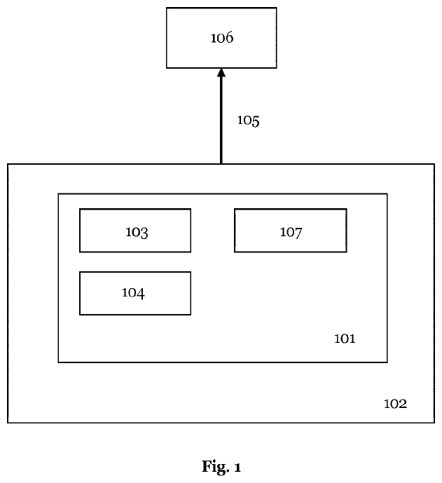

FIG. 1 is a schematic illustration of a system according to the present invention. The system comprises a control module 101 configured to be coupled to a gate controller 102 of an electrical gate system. The gate controller 102 is configured to provide status information regarding a status of the electrical gate system via an interface 105. A local device 106 can be connected to this interface 105 by means of which a local user can be informed about the status of the electrical gate system. The control module 101 is configured to automatically access the status information and provide the status information to processing means 103, wherein the processing means 103 is configured to process the status information and provide the processed status information to a communication module 104 coupled to the control module 101. The communication module 104 is configured to communicate the processed status information to a remote maintenance unit (not shown).

On the manufacturer's side, the status information provided by the gate controller 102 is generally intended merely for informing a local user. This can be done, for example, by means of a local device such as a local display 106 coupled to the gate controller 102 via the interface 105. The control module 101 according to the invention is therefore configured such that it can automatically access the status information and provide it to the processing means 103. In an advantageous embodiment, the control module 101 here accesses, by means of signal tapping means 107, a signal comprising the status information and transmitted to the local display 106 via the display interface 105. The signal tapping means 107 are embodied here, for example, as optical couplers which make it possible to tap the signal transmitted via the display interface 105.

The signal tapped in this way is then processed by the processing means 103. In particular, the processing means 103 are configured to decode the tapped signal in order thus to provide the contained status information in processable form to the communication module 104. By means of the communication module 104, the status information thus obtained can be transmitted to a remote maintenance unit for remote diagnosis and corresponding remote maintenance.

The status information can comprise a multiplicity of parameters which allow detailed remote diagnosis of the state of an electrical gate system and, based on the diagnosis results, efficient and effective remote maintenance. The status information comprises, by way of example, motor status information relating to the motor of the electric gate system, including parameters such as torque, current and position of the drive shaft.

Furthermore, the status information can comprise, for example, gate control status information which characterizes the status of the gate control. This information includes, in particular, a fault status which describes a possible fault state of the gate control.

Communication by means of the communication module 104 takes place, for example, via wireless mobile radio using at least one telecommunication standard and/or at least one communication protocol such as WLAN, Bluetooth LE, GSM, EDGE, LTE-M or NB-IOT.

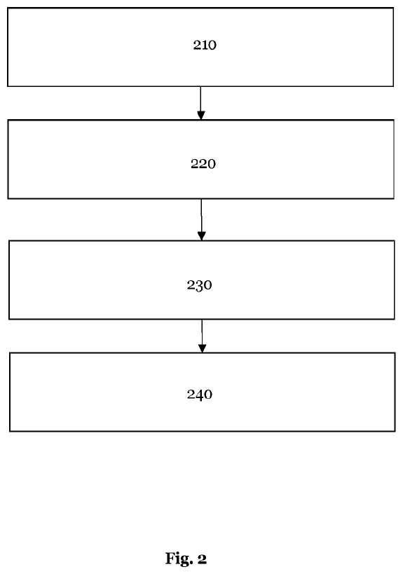

FIG. 2 is a flowchart relating to the operation of the method according to the present invention. The method for remote diagnosis and remote maintenance of an electrical gate system comprises providing 210, by a gate controller 102 of an electrical gate system, status information regarding a status of the electrical gate system via an interface 105 to which a local device 106 can be connected by means of which a local user can be informed about the status. The method further comprises automatically accessing 220, by a control module 101 coupled to the gate controller 102, the status information and providing the status information to processing means 103. The method further comprises processing 230, by the processing means 103, the status information and providing the processed status information to a communication module 104 coupled to the control module 101. In addition, the method comprises communicating 240, by the communication module 104, the processed status information to a remote maintenance unit.

As explained in conjunction with FIG. 1, the status information provided by the gate controller 102 is generally intended merely for informing a local user on the manufacturer's side. The method according to the invention therefore comprises automatically accessing the status information and providing the status information to the processing means 103. As explained above, in an advantageous embodiment, the status information is provided to the local user by means of a local display 106. The local display 106 is coupled to the control module 101 by means of a display interface 105. As explained above, the control module 101 automatically accesses by means of signal tapping means 107 which access a signal comprising the status information and transmitted to the local display 106 via the display interface 105. As likewise explained above, the signal tapping means 107 comprise here, for example, an optical coupler which makes it possible to tap the signal transmitted via the display interface 105 and thus obtain the status information encoded in the signal.

The invention makes it possible for different gate controllers to be diagnosed remotely, for example by a remote maintenance unit, and correspondingly for maintenance measures to be initiated. The cooperation of a user on site, such as, for example, maintenance personnel, is not required for detecting the status information. By means of the signal tapping means 107 according to the invention, which comprise, for example, an optical coupler, it is possible, in particular, to detect status information relating to a status of the monitored electrical gate system and to provide it for further processing, although this status information can be intended merely for informing a local user on site on the manufacturer's side. The present invention thus represents a largely manufacturer-independent solution which can be integrated both in new systems and in existing systems.

As can be seen from FIG. 1, the system according to the invention consists of a control module 101 which, in addition to manufacturer-specific and controller-specific connections, comprises a processing means or logic module 103 and a communication module 104. The control module 101 is coupled via the manufacturer-specific and controller-specific connections to the respective gate controller of an electrical gate system to be monitored remotely.

The control module 101 is supplied with voltage via a voltage input coupled to the respective gate controller. The processing means or logic module 103 is designed to be non-manufacturer-specific and non-controller-specific and, together with the communication module 104, takes over computing requirements arising and the data communication with the remote maintenance unit. The control module 101 is preferably installed within a respective gate controller, for example by means of a housing for protecting the contained electronic components of the control module 101.

The invention makes use of the fact that the status information provided by the gate controller merely for informing a local user is transmitted in the form of an encoded signal via a display interface to a local display (screen). According to the invention, the signal is tapped by means of an optical coupler coupled to the display interface. A further advantage of the invention is that, for reading off status information possibly intended merely for the local display on the manufacturer's side, no local user interaction is required and, instead, remote diagnosis and corresponding remote maintenance are possible.

By using telemetry, the invention makes it possible to continuously monitor the state of one or more gate controllers for corresponding electrical gate systems. In this way, it is possible, for example, to prevent unplanned failures of gate controllers and therefore of the respective electrical gate systems. The invention also allows predictive maintenance and fast-response service, for example also by maintenance personnel on site, if a corresponding necessity arises from the remote diagnosis. The invention further makes it possible to reduce failure risks and maintenance costs and energy losses and safety risks owing to unclosed electrical gate systems.

As explained at the outset, electrical gate systems, such as, for example, industrial gates, are used, inter alia, in critical infrastructure, in producing companies and in traffic infrastructure. Thus, industrial gates are used in large numbers in buildings such as, for example, industrial halls.

The operation of such buildings requires, inter alia, a high energy expenditure in order to set and maintain a desired room climate in a building such as an industrial hall. In addition to temperature and air humidity in the building, the room climate can be characterized by a large number of further parameters, for example air pressure, carbon dioxide and carbon monoxide content of the interior air and further parameters such as degree of turbulence, hazardous material load or noise level. The room climate is also influenced by exterior environmental data, such as, for example, the temperature, the air pressure and the humidity in the exterior environment of the building.

The degree of turbulence is a measure of the fluctuation in the air velocity and is specified as the ratio of the standard deviation of the air velocity to the mean air velocity. By taking account of the degree of turbulence, it is possible, for example, to prompt measures for optimizing the thermal comfort for the people in the buildings or halls.

The invention thus makes it possible, for example, to detect improperly set supply air passages, for example by means of an anemometer coupled to the detection unit according to the invention. This comprises, for example, checking whether a volume flow is set too high or too low or an incorrect operating mode is set (for example heating operation with cool supply air and too great a temperature difference between supply air and room air). Accordingly, the invention makes suitable action recommendations for countermeasures possible.

The invention can also contribute to room ventilation for eliminating process-related thermal loads, in particular if the air guidance is implemented according to the principle of laminar flow.

On account of their spatial dimensions and small ventilation areas (for example windows), buildings such as, for example, industrial halls cannot always be adequately ventilated by means of natural or technical ventilation. The invention can give corresponding action recommendations to carry out repeated, short or long gap or impact ventilation and, in interaction, to open and close a plurality of electrical gate systems in a coordinated manner for systematic and correspondingly effective transverse ventilation. Free ventilation in a building such as an industrial hall can also take place, for example, by thermal processes. However, the prerequisite for this is that air can escape in the upper region of the hall and fresh air can flow on in the region close to the floor by intelligent opening of the electrical gate systems. However, the air exchange then also depends on pressure and temperature differences inside and outside the hall. The effectiveness is also weather-dependent. Such an adequate air exchange takes place only in the case of adequate temperature differences between the inside and outside or if it is sufficiently windy. Thus, for example, natural ventilation can be virtually ineffective in spring in the case of wind silence and exterior temperatures of +20 °C. On account of this dependence, a specific air exchange rate cannot be automatically expected in the case of free ventilation. By contrast, the invention takes account of these parameters and, as in further embodiments, of customer-specific circumstances, for example. In particular, the invention can take account of the geographical position of individual electrical gate systems and the respective spatial geometry and can thus ensure effective ventilation (air exchange rate)—even in regions of a hall remote from gates and windows—even in the case of small temperature differences between the inside and outside. In further embodiments, the invention can make corresponding results of the measures taken visible to the user in a calculative manner by means of suitable software.

In a further embodiment, the invention makes it possible to optimize a required supply air volume flow corresponding to loads actually arising.

In a further embodiment, the invention makes it possible to carry out required ventilation according to a required air exchange rate. In the case of cold, dry outside air in winter, a lower air exchange rate can be expedient, for example. The different parameters such as weather and material emission sources are thus mapped in an overall model.

The detection of the carbon dioxide content (CO₂) in the interior makes it possible, for example, to optimize combustion processes of systems and processes, based on the determined action requirement. This makes it possible, for example, to improve ventilation concepts, for example by means of suitable coordinated opening intervals of the electrical gate systems in a hall.

The invention makes it possible, for example, to detect particular hazards in the industrial environment, caused, for example, by carbon monoxide from exhaust gases. This makes it possible to take suitable measures quickly and in a targeted manner, such as, for example, impact ventilation and transverse ventilation by means of the electrical gate systems.

Since a building such as, for example, an industrial hall generally has a relatively large number of industrial gates, the room climate in the industrial hall is influenced substantially by the state of the respective industrial gates. In particular, long and frequent open service lives and uncoordinated opening and closing processes can bring about a considerable energy loss, for example if there is a high difference between interior temperature and exterior temperature. In this case, both heat and cold can escape from the building through opened industrial gates and bring about a corresponding energy loss. Industrial gates which are opened unnecessarily far or for a long time can also allow disruptive sound emissions to pass from the interior to the exterior. It is likewise possible for sound emissions from the exterior region, for example road noise or construction noise, to pass into the interior of the building and thus negatively influence the room climate.

If high sound emissions prevail in an industrial hall, for example owing to the production environment, the invention makes it possible to optimize ventilation processes. In this case, according to the invention, emission sources outside the building (for example adjacent production buildings, road noise, construction sites) or air pollution can also be taken into account.

The invention solves the said problems by providing a detection unit for electrical gate systems, with which a precise determination of an action requirement is made possible. Inter alia, it can be detected by means of the invention that a current room climate deviates from a desired room climate, and a corresponding action recommendation can be output in order to adapt the current room climate accordingly. The detection unit according to the invention is able to report the determined action requirement in suitable form, for example by acoustic and/or visual signals, so that a user on site can be alerted to the current situation and, for example, can be warned of an imminent or acute energy loss. In addition or as an alternative, the detection unit can also forward a corresponding report to a user who is not on site, for example by sending a notification to a mobile device such as a mobile phone or a tablet of the user. As a further possibility, the detection unit can also transmit a corresponding report to a remote maintenance unit. In this way, suitable measures for restoring the desired room climate can be carried out quickly, for example by partially or completely closing an electrical gate system or, in the case of a plurality of electrical gate systems, by correspondingly coordinated opening and closing.

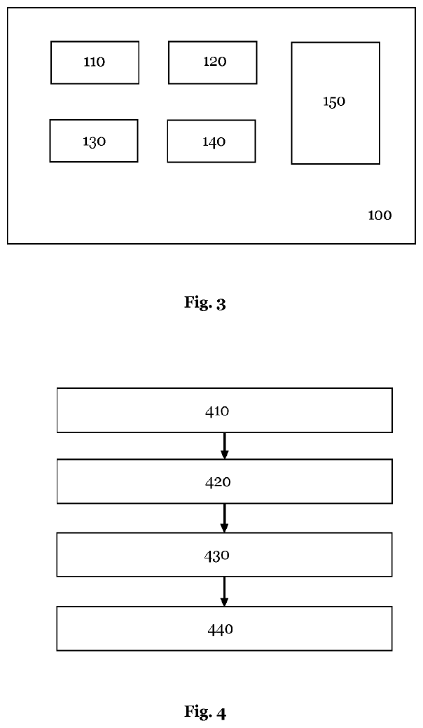

FIG. 3 is a schematic illustration of a detection unit according to an embodiment of the present invention. The detection unit 100 for an electrical gate system comprises coupling means 110 for coupling the detection unit 100 to a gate controller of the electrical gate system. The detection unit 100 can thus already be fitted during the installation of the electrical gate system or can also be used subsequently as a retrofit solution for existing electrical gate systems.

The detection unit 100 further comprises environmental data detection means 120 configured to detect environmental data such as, for example, interior environmental data and exterior environmental data. The interior environmental data comprise, for example, the parameters explained above such as interior temperature, interior air pressure and interior humidity, while the exterior environmental data can comprise exterior temperature, exterior air pressure and exterior humidity. For a more precise determination of the room climate, further interior environmental data can be detected, such as, for example, carbon dioxide content, carbon monoxide content and degree of turbulence of the interior air, but also a hazardous material load of the interior air or a noise level prevailing in the interior.

The detection unit 100 also comprises status detection means 130 configured to detect a status of the electrical gate system from the gate controller. The status of the electrical gate system can comprise different information, such as, for example, gate position information relating to a position of the electric gate system (inter alia open position and a closed position), time information relating to a duration of a current status of the gate and gate control status information relating to a status of the gate control, including a fault status.

The above-mentioned action requirement detection means 140 of the detection unit 100 serve to determine an action requirement which is based on the detected environmental data and the detected status. Furthermore, the detection unit 100 comprises reporting means 150 configured to report the determined action requirement.

In order to inform a user on site about the determined action requirement and to prompt him, for example, to take action, the reporting means 150 comprises signaling means configured to provide a visual and alternatively or simultaneously acoustic output. For example, a visual output can take place with lighting means such as LEDs which indicate the determined action requirement in certain warning colours and/or with certain light patterns and make it clearly detectable as a warning indication for a local user.

In order that a determined action requirement can be perceived even when no user is on site and within visual range of the electrical gate system, the reporting means 150 is further configured to report the determined action recommendation by means of transmission means. In particular, a corresponding report with the action recommendation can be sent wirelessly (or by wire) to a remote user such as a remote maintenance unit. Alternatively or additionally, a report can be sent to a mobile device such as a mobile phone or a tablet of a user who is currently not on site and cannot perceive a visual or acoustic signaling on site. The report can, for example, take place visually alternatively or simultaneously acoustically by a corresponding application on the mobile terminal of the user in order thus to prompt him to take action.

As explained above, a corresponding report can simultaneously comprise an action recommendation which is based on the determined action requirement. In this way, a user or the remote maintenance unit can quickly take suitable measures.

Since the detection unit 100 can be coupled to the gate controller of the electrical gate system by means of the coupling means 110, the state of the electrical gate system can be detected very exactly. In particular, the position of the electric gate system, i.e. the open state, can be queried exactly, since the drive state of the drive of the electric gate system can be read out. In this case, the drive state defines an opening area of the electric gate system. The detection unit 100 can in this way not only detect whether the electric gate system is “on” or “off”, but instead can precisely detect which opening area the gate system has. According to the invention, the state of the electric gate system is thus determined, for example with regard to the gate opening, i.e. the open state, wherein for this purpose the actual drive state of the drive of the electric gate system is read out from the gate controller. This can take place in increments of the actual percentage gate open state.

The invention also allows a temperature profile to be calculated directly at the gate, based in particular on the detected exterior temperature and the detected interior temperature and further data such as the exterior air pressure and the interior air pressure.

In addition, as explained above, the detection unit 100 can read out a possible fault status of the gate controller of the electric gate system, from which an acute action requirement can likewise arise, for example if the gate controller is faulty such that opening or closing of the electric gate system is not possible. In this case, a visual and alternatively or simultaneously acoustic report as a warning and indication for a local user is particularly helpful, as is a corresponding report to a remote user such as the remote maintenance unit, in order to remedy the fault state as quickly as possible.

The detection unit 100 according to the invention can in particular detect an imminent or already occurred energy loss. For this purpose, determining the action requirement comprises correspondingly calculating an energy loss based on a comparison of the interior environmental data and the exterior environmental data. Further, the calculation takes account of the status of the electric gate system, in particular the position of the gate system and the duration of the current status. The position of the electric gate system can in this case be detected exactly by detecting the drive state of the drive, in order thus to determine the precise opening area of the electric gate system. As further factors, the spatial position of the electric gate system and the area of the room in which the electric gate system is installed can be included in the calculation of the energy loss.

In a typical example scenario, the electric gate system is fully or partially open for a relatively long time, wherein the exterior temperature is very low in comparison with the interior temperature. This can very quickly lead to a high energy loss. Thus, for example, in the case of a typical industrial hall temperature-controlled to 18° Celsius per minute open service life and average annual temperature, an energy loss of approximately 0.5 to 0.8 kWh already arises in the case of an electric gate system with 25 m 2 opening area. In a further typical example scenario, the energy consumption for a four-minute opening of an electric gate system at exterior temperatures between −10°C and +10 °C can vary between 2 and 5 kWh, depending on the weather situation and the respective gate position. Thus, the duration and frequency of open gate states directly influence the energy expenditure in order to restore a desired hall temperature by means of heating processes. A corresponding energy loss also arises in the opposite case if a lower temperature in comparison with the exterior temperature is desired in the industrial hall, for example for cooling purposes.

The present invention allows the detection of a corresponding action requirement, which can be reported to a user on site and alternatively or simultaneously to a remote maintenance unit, in order to be able to react quickly and effectively to the situation on site and in particular to a detected energy loss.

In a further embodiment, the present invention also makes it possible to determine a current room climate based on the status of the electric gate system and the detected environmental data and to compare the current room climate with a predetermined room climate. The predetermined room climate can be a desired room climate, which can be, for example, a certain temperature, an air pressure, a maximum carbon dioxide and carbon monoxide content of the interior air and further parameters such as degree of turbulence, a maximum hazardous material load or maximum noise level. Based on the result of comparing the current room climate with the predetermined room climate, a corresponding action recommendation can be carried out, which is suitable for adapting the current room climate, so that the desired room climate is restored.

Since the current room climate is influenced in particular by the exterior environmental data such as, for example, the exterior temperature, the exterior air pressure and the exterior humidity in the exterior environment of the building and the state of the electric gate system, in particular the degree of open state, an action recommendation can consist, for example, in at least partially or completely opening or closing the electrical gate system for a certain period of time.

In particular in the case where a building such as an industrial hall comprises a plurality of electrical gate systems, in particular industrial gates, according to the present invention, correspondingly coordinated opening or closing of the one or more industrial gates can bring about ventilation and therefore an air exchange, in order, for example, to reduce an excessively high pollutant load owing to dust, carbon dioxide or another hazardous material load. In addition or as an alternative to a high pollutant load, for example, a high sound load owing to sound emissions from the exterior region can be reduced by closing the one or more industrial gates. Conversely, by closing the one or more industrial gates, a sound load of the exterior region owing to sound emissions from the industrial hall into the exterior region can be reduced.

The room climate in the object and industrial regions is influenced significantly by the building construction, the building technology, the exterior climate and the opening and closing frequencies of the individual building closures, in particular electrical gate systems. The system according to the present invention takes account of each electrical gate system in a building complex individually. This makes it possible, inter alia, to carry out energy efficiency calculations taking account of the individual cubical plan and the floor plan of a building, the individual user behavior and chimney effects. The invention can also contribute to avoiding undesired transverse ventilation owing to an unfavorable combination of gate open-stand states (for example in relation to or over the corner, chimney effect, draft air, air vortices).

The present invention can also be used to store the detected data for further analysis in order to develop strategies for increasing the efficiency, for example for hot-air heating and cooling (for example with regard to effective use of radiators/heating bodies, hot-air heaters, light radiators, dark radiators, central and decentralized air conditioning units, ceiling radiant panels, surface heating and cooling or concrete core activation) and in relation to optimum air purity and air quality.

The action recommendations according to the invention can comprise, inter alia, measures for reducing an increased room temperature, such as, for example, effective control of a sun shade (for example, blinds can be regulated according to the position of the sun), keeping the electrical gate systems closed as soon as it is warmer on the outside than on the inside, effective control of ventilation devices (for example intensified night ventilation by correspondingly coordinated opening and closing of the electrical gate systems), reducing internal thermal loads, coordinated ventilation by the electrical gate systems in the early morning hours in the summer etc.

Furthermore, problems which occur daily in the context of the determination of an action requirement can be detected with the present inventions in machines and processes in halls with personnel (operational, hygienic and health reasons) relating to draft air, dry air, excessively high air temperatures and excessively strong solar irradiation and also noxious air or unpleasant odors, and corresponding action recommendations can be reported, with the result that corresponding measures can be initiated in order to counteract a misdevelopment, for example in systems of the respective hall.

The reporting according to the invention of the determined action requirement and optionally of the correspondingly determined action recommendation makes it possible, for example by means of visual and alternatively or simultaneously acoustic signals such as, for example, push messages of an application on a wireless mobile terminal, LED signals or acoustic signals which are output directly by the detection unit 110, to inform users on site and optionally to bring about a change in behavior of the user on site.

The invention also makes a network and benchmarking approach possible. For example, the environmental data and the respective status of an electrical gate system can be detected for a multiplicity of electrical gate systems which can be distributed over different systems of a city (for example fire stations in districts) or furthermore in different locations in the country or worldwide. Corresponding benchmarking and best practice approaches can be generated from the detected data.

As explained above, the invention not only focuses on an energy loss as a result of heat loss, but also functions “in the other direction” and can likewise determine an action requirement in the event of an energy loss as a result of cold. This results in additional benefits for those users in which cooling is important (for example cold stores, pharmaceutical industry or beverages and foodstuffs).

A further embodiment relates to an electrical gate system which comprises the detection unit 100 presented above. Preferably, the detection unit is installed in the immediate vicinity of the electric gate system in order to be able to detect the interior environmental data with sufficient accuracy, for example at a distance of at most 5 m from the electric gate system, measured from a gate frame of the electric gate system.

A further embodiment comprises a building comprising one or more of the electrical gate systems explained above with in each case one of the detection units 100 explained above.

A further embodiment relates to a method for the detection unit 100 explained above. FIG. 4 is a flowchart relating to the operation of the respective method according to the present invention. The method comprises, inter alia, the steps of detecting 410 environmental data, detecting 420 a status of the electric gate system, determining 430 an action requirement based on the detected environmental data and the detected status, and reporting 440 the determined action requirement.

A further embodiment relates to a computer-readable storage medium comprising instructions which, when executed by a computer, cause the latter to carry out the method presented above.

The detection of the environmental data and the status of an electrical gate system and the determination of an action requirement based on these data can be carried out continuously, preferably in real time, and thus makes it possible, inter alia, to report regularly, for example on energy efficiency, open states and corresponding energy savings or energy losses. The action recommendations and the actions carried out thereupon can also be taken into account for the reporting. Further data, such as weather data from external sources, for example from the Internet or from a corresponding server, can also be included in the exterior environmental data for the data explained above and measurable on site.

Overall, the present invention thus makes it possible, inter alia, to determine an action requirement, for example triggered by an imminent or acute energy loss. The invention also makes it possible to adapt a current room climate to a desired room climate, in order thus to ensure, for example, advantageous and/or defined working conditions for personnel in the industrial hall and in the exterior region of the industrial hall.

The apparatuses, methods and systems disclosed here can be coupled to a meta controller in a further embodiment. The meta controller comprises means for controlling a multiplicity of local, conventional (analog) controllers of the existing gates, in order thus to improve, for example, the efficiency, safety and user friendliness of gates. In particular, the meta controller allows integrated and intelligent control, specifically in the case of objects with a multiplicity of gate systems in existence, also relating to different controller manufacturers and gate types.

In particular, the meta controller allows the following functions:

Centralized controller: The meta controller comprises means for centralized control of a multiplicity of gates, even at different locations. This facilitates the management and monitoring of gates in different buildings or facilities.

Automation and scheduling: The meta controller comprises means for defining automatic schedules for the opening and closing of gates. This is useful for the operation of gates in industrial or public environments, where access is restricted at certain times. Access rights for a multiplicity of gates can be regulated by means of user and access management. As an example, access to underground garage gates can be enabled by the local home management for a time-defined service deployment.

Integration with other systems: The meta controller integrates a multiplicity of local, conventional (analog) controllers of the existing gates seamlessly with other systems, such as, for example, safety and alarm monitoring systems, in order to provide a comprehensive safety solution for gates. The meta controller further comprises means for controlling HVAC (heating, ventilation, air conditioning) systems and other relevant facilities in real time, in order to optimally regulate the room climate. For example, the meta controller comprises means for adapting the air supply, heating, cooling and ventilation according to the current conditions, in order to maximize the thermal comfort.

Adaptive controller: The meta controller comprises means for learning how different conditions affect the behavior of the gates by the analysis of real-time data and environmental parameters. This makes adaptive control possible, in which the opening and closing times can be adapted accordingly in the case of a multiplicity of local, conventional (analog) controllers of the existing gates, in order to optimize the traffic flow or save energy.

Object detection and tracking: The meta controller comprises means for detecting and tracking objects by means of image processing algorithms. This can be used specifically in order to ensure that no persons or vehicles are located in the danger region of the gates before they are closed. On the basis of the shape of the approaching objects, for example, the opening heights of the respective gate opening operations are controlled individually in the case of a multiplicity of local, conventional (analog) controllers of the existing gates. In the case of a 5-metre-high gate, for example, only half an opening height is required when a 2-metre-high vehicle approaches. The meta controller further comprises means for learning, over the longer term and on the basis of the collected data, which opening heights are required overall for the respective gates in the respective installation situations.

User personalization: The meta controller comprises means for learning to detect the preferences and behavior patterns of individual users by the analysis of use data. This allows personalized control in the case of a multiplicity of local, conventional (analog) controllers of the existing gates, in which, for example, preferred opening times or access rights are taken into account.

Contextual control: The meta controller comprises means for detecting and analyzing contextual information such as, for example, weather conditions, traffic volumes or specific events. Based on this information, dynamic adaptation can take place in the case of a multiplicity of local, conventional (analog) controllers of the existing gates, in order to meet the current requirements and to achieve optimal performance.

Automatic fault detection and correction: The meta controller comprises means for automatically detecting faults or anomalies in the operating data in the case of a multiplicity of local, conventional (analog) controllers of the existing gates and for initiating corresponding measures for fault correction. This can contribute to minimizing downtimes and to increasing the reliability of the gates.

Optimization of the air quality: The meta controller comprises means for continuously monitoring and improving the air quality in buildings such as industrial halls. In this case, for example, exterior environmental data such as temperature, air pressure and humidity are taken into account in order to optimize the room climate. The meta controller comprises means for adapting, for example, the air supply and air circulation on the basis of the external conditions in the case of a multiplicity of local, conventional (analog) controllers of the existing gates and thus, for example, maintaining a pleasant ambient temperature. The meta controller further comprises means for automatically optimizing the ventilation by intelligent transverse ventilation of the different gate systems by the analysis of data about the content of pollutants such as carbon dioxide and carbon monoxide and other air-borne hazardous materials and in this way ensuring a healthy and safe environment for the users.

### Further Embodiments

1. Detection unit (100) for an electrical gate system, comprising:
   coupling means (110) for coupling the detection unit (100) to a gate controller of the electrical gate system;
   environmental data detection means (120) configured to detect environmental data;
   status detection means (130) configured to detect a status of the electrical gate system from the gate controller;
   action requirement detection means (140) configured to determine an action requirement based on the detected environmental data and the detected status; and
   reporting means (150) configured to report the determined action requirement.
2. Detection unit (100) according to embodiment 1, wherein the reporting means (150) comprises one or more from the following list:
   signaling means configured to provide a visual and/or acoustic output; and transmission means configured to transmit to a remote receiver.
3. Detection unit (100) according to embodiment 1 or 2,
   wherein the action requirement detection means (140) is further configured to determine an action recommendation based on the determined action requirement; and
   wherein the reporting means (150) is further configured to report the determined action recommendation.
4. Detection unit (100) according to one of the embodiments 1 to 3,
   wherein the detected environmental data comprise interior environmental data and exterior environmental data.
5. Detection unit (100) according to embodiment 4,
   wherein the interior environmental data comprise one or more from the following list:
      an interior temperature, an interior air pressure, an interior humidity, a carbon dioxide content of the interior air, a carbon monoxide content of the interior air, a degree of turbulence of the interior air, a hazardous material load of the interior air, a noise level; and
   wherein the exterior environmental data comprise one or more from the following list:
      an exterior temperature, an exterior air pressure, an exterior humidity.
6. Detection unit (100) according to one of the embodiments 1 to 5,
   wherein the detected status of the electric gate system comprises one or more from the following list:
      gate position information relating to a position of the electric gate system, comprising an open position and a closed position;
      time information relating to a duration of a current status of the electric gate system; and
      gate control status information relating to a status of the gate control, including a fault status.
7. Detection unit (100) according to embodiment 6,
   wherein the gate position information relating to a position of the electric gate system is based on a drive state of a drive of the electric gate system, and
   wherein the drive state defines an opening area of the electric gate system.
8. Detection unit (100) according to one of the embodiments 2 to 7,
   wherein reporting the determined action requirement comprises reporting the determined action requirement to a remote maintenance unit using the transmission means.
9. Detection unit (100) according to one of the embodiments 7 to 8,
   wherein determining the action requirement comprises calculating an energy loss,
   wherein calculating the energy loss is based at least on one or more from the following list:
      a comparison of the interior environmental data and the exterior environmental data;
      the status of the electric gate system;
      the opening area of the electric gate system;
      a spatial position of the electric gate system; and
      an area of a room in which the electric gate system is installed.
10. Detection unit according to one of the embodiments 1 to 9,
   wherein determining the action requirement further comprises:
      determining a current room climate based on the status of the electric gate system and the environmental data; and
      comparing the current room climate and a predetermined room climate; and
   wherein the action recommendation is further based on a result of comparing the current room climate and the predetermined room climate and is suitable for adapting the current room climate to the predetermined room climate.
11. Electrical gate system, comprising the detection unit (100) according to one of embodiments 1 to 10.
12. Electrical gate system according to embodiment 11, wherein the detection unit (100) is installed in the immediate vicinity of the electric gate system, in particular at a distance of at most 5 m from the electric gate system, measured from a gate frame of the electric gate system.
13. System for a building, comprising the electrical gate system according to embodiment 11 or 12.
14. Method for a detection unit (100) according to one of the embodiments 1 to 10, the detecting (410) environmental data; detecting (420) a status of the electrical gate system; determining (430) an action requirement based on the detected environmental data and the detected status; and reporting (440) the determined action requirement.

15. Computer-readable storage medium comprising instructions which, when executed by a computer, cause the latter to carry out the method according to embodiment 26.

1. Method for remote diagnosis and remote maintenance of an electrical gate system, the method comprising:
providing (210), by a gate controller (102) of an electrical gate system, status information regarding a status of the electrical gate system via an interface (105) to which a local device (106) can be connected by means of which a local user can be informed about the status;
automatically accessing (220), by a control module (101) coupled to the gate controller (102), the status information and providing the status information to processing means (103);
processing (230), by the processing means (103), the status information and providing the processed status information to a communication module (104) coupled to the control module (101); and
communicating (240), by the communication module (104), the processed status information to a remote maintenance unit.

2. Method according to claim 1, wherein the interface (105) is a display interface and the local device (106) is a local display.

3. Method according to claim 2, wherein the automatically accessing (220) the status information comprises tapping, by signal tapping means (107), a signal transmitted via the display interface (105), the signal comprising the status information.

4. Method according to claim 3, wherein the processing (230) of the status information comprises decoding, by the processing means (103), the tapped signal comprising the status information.

5. Method according to claim 3 or 4, wherein the tapping comprises obtaining, by an optical coupler, the signal transmitted via the display interface (105).

6. Method according to claim 1, wherein the status information comprises one or more information from the following list:
motor status information relating to a status of a motor of the electric gate system, including torque and/or current and/or shaft position; and
gate control status information relating to a status of the gate control (102), including at least one fault status.

7. System for remote diagnosis and remote maintenance of an electrical gate system, comprising:
a control module (101) configured to be coupled to a gate controller (102) of the electrical gate system;
wherein the gate controller (102) is configured to provide (210) status information regarding a status of the electrical gate system via an interface (105) to which a local device (106) can be connected by means of which a local user can be informed about the status;
wherein the control module (101) is configured to automatically access (220) the status information and provide the status information to processing means (103),
wherein the processing means (103) is configured to process (230) the status information and provide the processed status information to a communication module (104) coupled to the control module (101);
wherein the communication module (104) is configured to communicate (240) the processed status information to a remote maintenance unit.

8. System according to claim 7, wherein the interface (105) is a display interface and the local device (106) is a local display.

9. System according to claim 8, wherein the control module (101) for automatically accessing (220) the status information comprises signal tapping means (107) configured to tap a signal transmitted via the display interface (105), the signal comprising the status information.

10. System according to claim 9, wherein the processing means (103) for processing (230) the status information is configured to decode the tapped signal comprising the status information.

11. System according to claim 9 wherein the signal tapping means (107) comprises an optical coupler configured to obtain the signal transmitted via the display interface (105).

12. System according to claim 7, wherein the status information comprises one or more information from the following list:
motor status information relating to a status of a motor of the electric gate system, including torque and/or current and/or shaft position; and
gate control status information relating to a status of the gate control (102), including at least one fault status.
